(19) United States
(12) Patent Application Publication
(10) Pub. No.: US 2018/0025428 A1
(43) Pub. Date: Jan. 25, 2018

(54) METHODS AND SYSTEMS FOR ANALYZING FINANCIAL RISK FACTORS FOR COMPANIES WITHIN AN INDUSTRY

(71) Applicant: XEROX CORPORATION, Norwalk, CT (US)

(72) Inventors: Arpit Jain, Bangalore (IN); Anirban Mondal, Greater Noida (IN); Rahul Ghosh, Bangalore (IN)

(21) Appl. No.: 15/216,995

(22) Filed: Jul. 22, 2016

(51) Int. Cl. G06Q 40/06; G06Q 30/02

(52) U.S. Cl. CPC G06Q 40/06; G06Q 30/0201

(57) ABSTRACT

The present disclosure discloses methods and systems for analyzing the financial reports of a plurality of companies of a particular industry, to identify one or more companies with different investment risks. A pre-defined section that corresponds to investment risk related qualitative details, is extracted from the financial reports of the plurality of companies, and a normalized feature vector is created. Next, a similarity between each normalized feature vector is computed, such that one or more companies with least similarity correspond to having different investment risks.

### TECHNICAL FIELD

The disclosed subject matter relates to intelligent processing of collected financial data. More particularly, the disclosed subject matter relates to identification of investment related risks using mined financial information for companies within an industry.

### BACKGROUND

As part of corporate operations, the companies are required to periodically generate financial reports that enumerate details such as income details, cash flow statements, details on assets and liabilities, and the like. These details can be utilized for taking key economic decisions. Examples of these decisions include, but are not limited to, deciding future business operations, seeking working capital from investors/banks, and deciding employee compensations. Most countries have their respective financial reporting principles for the companies operational in their respective geography. According to these principles, the companies have to submit financial reports based on a set of guidelines, and this submission can be made annually, quarterly, and/or monthly. Specifically, in the United States (U.S.), the Securities and Exchange Commission (SEC) lays regulations for reporting financial performance of public and private companies. SEC mandates that every company with $10+ million in assets and 500+ owners in equity securities must file their financial reports. As per the SEC, the reports that are filed annually are referred to as the 10K reports, while the quarterly counterparts are called 10Q reports. These reports are available in the public domain and can be obtained from SEC's website as well as from a wide gamut of other reliable sources online.

Typically, the financial analysts manually review the financial reports to assess the performance of any company. This review is conducted on numerous parameters and one of the key insights derived from the review is the investment risk associated with a company. An investment risk of a company is defined as the likelihood of occurrence of losses relative to an expected return on any particular investment. Further, an investment risk is generally calculated based on quantitative factors, an example of which includes the actual returns on stocks. Given the length of the financial reports, this manual analysis is cumbersome and prone to human error. Broadly, the financial reports (such as the 10K reports) consist of multiple sub-sections that span across multiple pages, and each sub-section contains unstructured text data and/or structured numerical data. Therefore, examining this data is time consuming. Further, since the technique of manual review is not based on scientific or technical inspection, there are chances of subjection of a human bias when analyzing data of multiple companies. This is because the financial reports may not necessarily disclose all associated risks and the financial analysts end up drawing inference from the partially available risk information. Another shortcoming is that the manual analysis is not easily amenable to cross-comparisons across companies in the same industry sector. In addition, since there is a plethora of data to be mined, this technique is not easily scalable.

Sometimes the financial analysts also take into account information from disparate sources (in addition to the financial reports) to identify investment risk-related insights. Even in case of disparate sources, the analysis is made on the basis of quantitative parameters. However, there already are contextual qualitative factors available within the financial reports that aid in adequate estimation of an investment risk. These qualitative factors correspond to the macro-environment factors, such as, but not limited to, political/legal, economic, social, demographic, technological, and the like. These factors are potentially overlooked while analyzing huge corpus of financial reports. A comprehensive understanding of the macro-environment factors is useful in identifying risks as well as for estimating a company's relative market risk positioning (with respect to other companies in the same business/industry sector).

Therefore, there is a need of a technique that automatically analyze the macro-environment factors associated with a company to reliably estimate inter-company and intra-company investment risks.

### SUMMARY

The present disclosure discloses a method for identifying one or more companies from a plurality of companies in an industry. The one or more companies have one or more investment risks different from investment risks of other companies in the plurality of companies. The identification is performed by a risk analysis server, in communication with a user device in a real-time. The method comprising receiving, by the risk analysis server, an industry categorization code of the industry through a user interface on the user device. The risk analysis server then identifies the plurality of companies belonging to the industry categorization code from one or more remote data sources. Next, the risk analysis server obtains financial reports corresponding to the plurality of identified companies from the one or more remote data sources. A common knowledge base is created by first extracting data from a pre-defined section of the financial reports of the plurality of companies, wherein the pre-defined section includes investment risk related qualitative details for the plurality of companies. A normalized feature vector is created corresponding to the extracted data of each of the plurality of companies. Thereafter, a similarity value is computed between each normalized feature vector for each of the plurality of companies, and the similarity values are stored in the common knowledge base. The risk analysis server then identifies one or more companies from the plurality of companies with least similarity values in the common knowledge base, wherein the least similarity values correspond to one or more investment risks different from investment risks of other companies in the plurality of companies. A list of the one or more companies is displayed to the user in a real-time, within the user interface.

Further, the present disclosure discloses a method for creating a common knowledge base for a plurality of companies in an industry. The common knowledge base stores one or more investment risk insights for each of the plurality of companies. The method comprising extracting a plurality of investment risk data from a pre-defined section of financial reports of the plurality of companies, wherein the pre-defined section includes investment risk related qualitative details for the plurality of companies, and the financial reports are accessed from one or more remote data sources. A normalized feature vector is created corresponding to the plurality of extracted investment risk data of each of the plurality of companies. Further, a similarity value is computed between each normalized feature vector for each of the plurality of companies, and the similarity values and the normalized feature vector are stored in a database. Next, the similarity values are processed to identify one or more investment risk insights for each of the plurality of companies, and the one or more investment risk insights for each of the plurality of companies are stored for further retrieval.

Moreover, the present disclosure discloses a method for identifying one or more missing investment related risk details in financial reports of one or more companies in an industry. The identification is performed by a risk analysis server. The method comprising obtaining, by the risk analysis server, financial reports corresponding to a plurality of companies of an industry from the one or more remote data sources. The risk analysis server creates a common knowledge base by first extracting data from a pre-defined section of the financial reports of the plurality of companies, wherein the pre-defined section includes investment risk related qualitative details for the plurality of companies. Next, a normalized feature vector is created corresponding to the extracted data of each of the plurality of companies, and a similarity value is computed between each normalized feature vector for each of the plurality of companies. Further, the risk analysis server identifies one or more investment related risks details available in a first set of the plurality of companies, the identification being made using the computed similarity values, wherein the one or more investment related risks are not present in a second set of the plurality of companies, the number of companies in the first set is greater than the second set.

In addition, the present disclosure discloses a risk analysis server for identifying one or more companies from a plurality of companies in an industry, the one or more companies having one or more investment risks different from investment risks of other companies in the plurality of companies. The risk analysis server comprises a request manager, a crawler, and a common knowledge base generator. The request manager is configured for receiving an industry categorization code of the industry from a user. The crawler is configured for identifying the plurality of companies belonging to the industry categorization code from one or more remote data sources, and obtaining financial reports corresponding to the plurality of identified companies from the one or more remote data sources. The common knowledge base generator is configured for creating a common knowledge base. The creation of the common knowledge base comprising extracting data from a pre-defined section of the financial reports of the plurality of companies, wherein the pre-defined section includes investment risk related qualitative details for the plurality of companies. Next, a normalized feature vector is created corresponding to the extracted data of each of the plurality of companies. A similarity value is computed between each normalized feature vector for each of the plurality of companies, and the similarity values are stored in the common knowledge base. One or more companies are identified from the plurality of companies with least similarity values in the common knowledge base, wherein the least similarity values correspond to one or more investment risks different from investment risks of other companies in the plurality of companies. The list of the one or more companies is then displayed to the user.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates an exemplary overall system configured for identifying an investment risk, according to an aspect of the disclosure.

FIG. 2 illustrates the schematic of the risk analysis server.

FIGS. 3A and 3B illustrate exemplary user interfaces for accessing the risk analysis server.

FIG. 4 illustrates a graphical layout of the processing ensued while performing cosine similarity.

FIG. 5 is a method for analyzing investment risks of companies in an industry.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

Definitions of one or more terms that will be used in this disclosure are described below without limitations. For a person skilled in the art, it is understood that the definitions are provided just for the sake of clarity, and are intended to include more examples than just provided below.

The term “financial report” refers to a formal record or statement of the financial activities and position of a company. Depending on the governing body of the country of operation, the companies are expected to submit the financial reports annually, quarterly, and/or monthly.

The details available in the financial reports are collectively known as “financial data” or “financial information.” Examples of the financial data includes, but is not limited to, income details, cash flow statements, details on assets and liabilities, management board, geographical operations, employee count, and the like.

An “investment risk” of a company is defined as the likelihood of occurrence of losses relative to an expected return on any particular investment.

The “Securities and Exchange Commission” (SEC) is a U.S. federal agency. One of its responsibilities includes overseeing the corporate financial, trading, and investment activities of the companies operating on the U.S. soil. According to the SEC guidelines, the financial reports filed annually by a company are called 10K reports, and the ones filed quarterly are called the 10Q reports. Further, the SEC has laid guidelines on the acceptable layout of the financial reports. Typically, the data in a financial report filed at SEC is first divided into a plurality of parts and then a plurality of sub-sections.

An “item 1A” corresponds to a sub-section in the financial reports submitted by the companies operating in the U.S. The item 1A is titled as “Risk Factors” and in this sub-section, the companies are required to discuss the most significant factors that make the company's operation risky. Examples of the risk factors include, but are not limited to, technology, political/legal, economic, and the like.

The term “Standard Industrial Classification” (SIC) refers to a four-digit code assigned to each industry, and each company is then categorized under an industry. For example, the dairy companies have a SIC code 2020, while companies selling/manufacturing beverages have a code 2080.

As used herein, a “risk analysis server” is a device equipped with a plurality of software/hardware components using which it intelligently examines the financial data available in the financial reports, particularly the details that correspond to item 1A. These details are evaluated using a natural language processing tool and the risk associated with each company, or companies within an industry is identified.

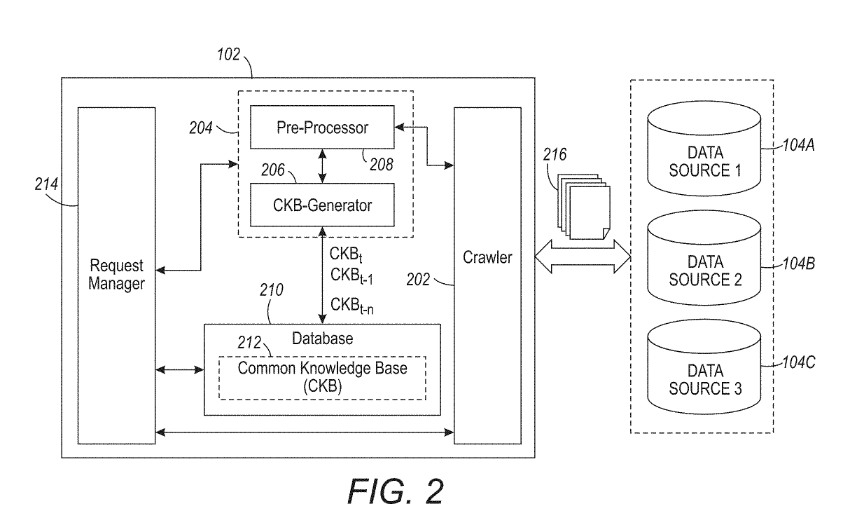

A “Common Knowledge Base” (CKB) is defined as a set of data that is built after processing the financial reports. The CKB presents aggregate risk characteristics of the companies within an industry sector, thereby reducing the effort needed to analyze the risk factors of the companies on an individual basis. Further, the set of data within the CKB is also characterized on a temporal scale using multiple metrics. In other words, the dynamic factors that affect a company's risks are taken into account and the set of data is accordingly updated. The details of the CKB will be discussed with respect to FIG. 2.

The term “outlier” refers to companies with significantly different type and/or number of risk factors mentioned in financial reports (such as the 10K reports) when compared to other companies belonging to the same industry. In other words, an outlier company is either doing exceptionally well, or it might be indulging in fraudulent practices.

A “user device” refers to a device that includes a processor/micro-controller and/or any other electronic component, or a device or a system that performs one or more operations according to one or more programming instructions. Examples of the user device include, but are not limited to, a desktop computer, a laptop, a personal digital assistant (PDA), a mobile phone, a smart-phone, a tablet computer, and the like.

A “user” may be any individual or an entity who can access the risk analysis server, via a plurality of user devices. Examples of the users include, but are not limited to, financial analysts, investment risk professionals, investors, auditors, accountants, researchers, media personnel, and the like.

### Overview

The present disclosure provides a technique for analyzing the financial reports of a plurality of companies of a particular industry, to identify a sub-set of companies with different investment risks.

Here, the present disclosure discloses methods and systems for extracting a pre-defined section from the financial reports of all companies in an industry. The pre-defined section corresponds to item 1A and it enunciates the macro-environmental investment risk factors associated with each company. The data in item 1A is parsed using natural language processing tool and a normalized feature vector is created for the financial report of each company. The normalized feature vectors of all companies in the industry is then compared using a similarity metric to identify the outliers, i.e., the companies with least similarity. In other words, the companies that have the high or different investment risks, or the companies that are performing exceptionally well contrary to industry expectation, thereby may be potentially involved in fraudulent practices. The present disclosure also facilitates users to ensure completeness of declaration of risk factors under item 1A.

### Exemplary Overall System

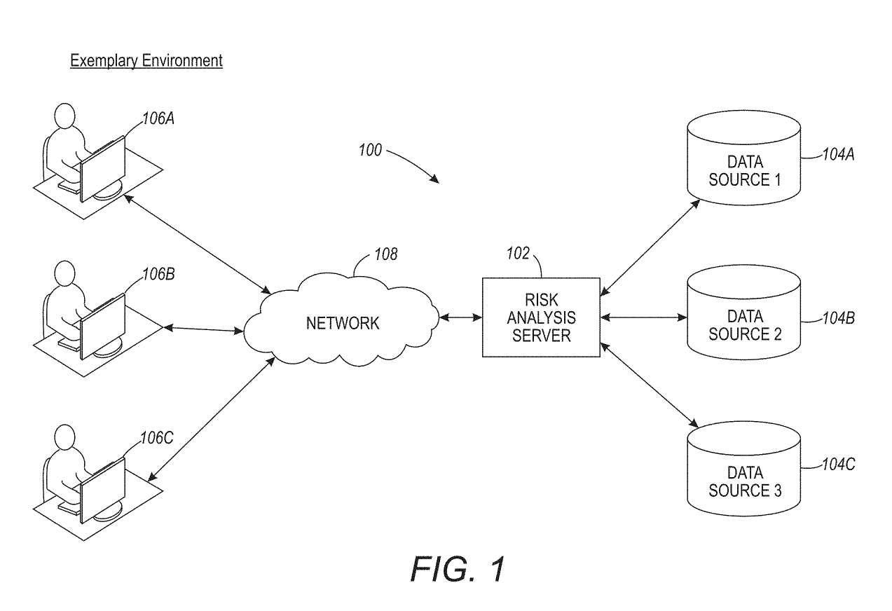

FIG. 1 illustrates an exemplary overall system 100 configured for identifying an investment risk, according to an aspect of the disclosure. The system 100 includes a risk analysis server 102, a plurality of data sources (first to third data sources 104a-104c), and a plurality of users (first to thirds users 106a-106c). The risk analysis server 102 is accessible to the plurality of users (such as a user 106a) over a network 108. The plurality of users can query the risk analysis server 102 to seek information on the investment risk of companies in an industry. This query can be made by employing one or more user devices (not shown in FIG. 1). Various examples of the user devices include, but are not limited to, desktop computers, laptops, mobile phones, smart phones, Personal Digital Assistant (PDA), tablets, and the like. Further, the network 108 can be a wired link or a wireless link, such as but not limited to, a Local Area Network (LAN), a Wide Area Network (WAN), a Wi-Fi network, a carrier based data packet network, and the like.

The plurality of data sources correspond to the publically available repositories that host financial reports of a plurality of companies. In an embodiment of the disclosure, when the companies are based out of the U.S. a data source 1 corresponds to the Securities and Exchange Commission's (SEC) website. The SEC is essentially a government body that manages the financial, trading, and investments related details of the companies operating within the U.S. The SEC mandates the companies to submit their financial reports each year and each quarter, and these financial reports are then made available to the public via SEC's website. In another embodiment of the disclosure, a data source 2 corresponds to the home website of a company where its financial reports are displayed. In yet another embodiment of the disclosure, a data source 3 can be one or more websites that mine financial reports from the SEC's website and/or from the companies' websites, and then display this information comprehensively on their own interfaces. Examples may include, but are not limited to, Yahoo Finance, Google Finance, Thomson Reuters, Bloomberg, and the like.

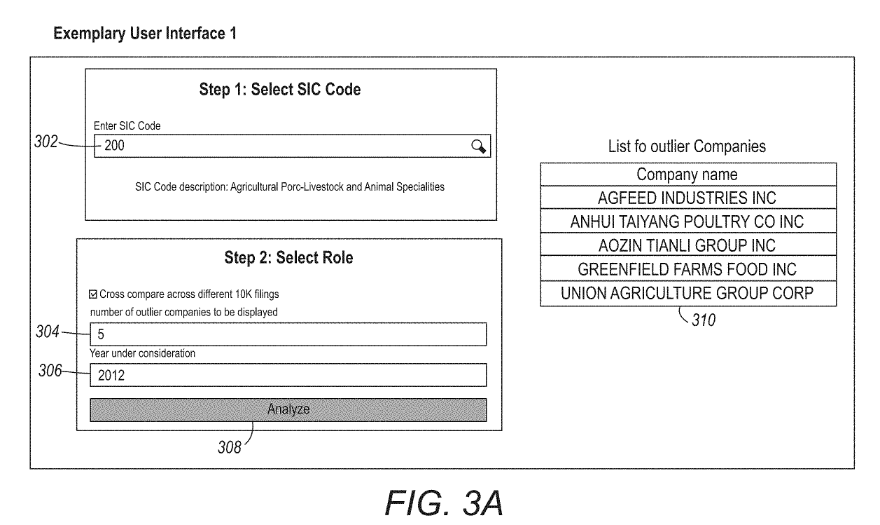

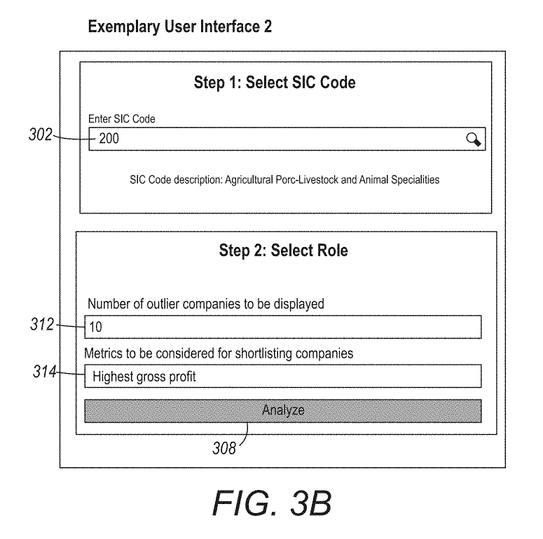

The risk analysis server 102 is configured to remotely connect with the plurality of data sources over wired or wireless connections. The risk analysis server 102 mines the financial reports from at least one of the plurality of data sources using one or more computer programs, and stores the mined information. In an embodiment of the disclosure, the risk analysis server 102 obtains the financial reports by means of EXtensible Markup Language (XML) or JavaScript Object Notation (JSON) feeds. This step is triggered when the risk analysis server 102 receives a request/query from one of the user devices. This will be explained in detailed with respect to FIG. 2 and FIG. 3.

In another embodiment, one or more automated tools can be employed to periodically access the plurality of data sources to mine the financial reports. Essentially, the SEC has laid down timelines for companies to submit the financial reports. For example, the companies are required to submit their quarterly financial reports (known as the 10Q reports) within 40-45 days of the end of previous quarter. Similarly, the timeline for submitting annual reports (known as the 10K reports) is within 60-90 days of the end of the previous financial year. Therefore, the risk analysis server 102 can be programmed to learn when the quarterly and/or annual reports of companies are expected to the displayed on the SEC's website. Accordingly, the mining of financial reports is initiated. In an embodiment of the disclosure, the risk analysis server 102 primarily relies on the financial reports available on the SEC's website. In case the reports are not displayed on the SEC's website, the risk analysis server 102 uses other data sources (such as the home websites, or other financial news websites) to obtain the financial reports. In another embodiment, the risk analysis server 102 can be programmed to prioritize other data sources over the SEC's websites. In yet another embodiment, the risk analysis server 102 mines financial reports from all available data sources and correlates the financial data for accuracy.

The risk analysis server 102 analyzes the mined financial reports, and identifies the companies in an industry with potential investment risks. This analysis is made using contextual qualitative details available in item 1A of the financial reports, called the macro-environmental risk factors. Examples of the macro-environmental risk factors include, but are not limited to, political/legal, economic, social, demographic, technological, and the like.

### Risk Analysis Server

FIG. 2 illustrates the schematic of the risk analysis server 102. The risk analysis server 102 includes a crawler 202, a processor 208, a database 210, and a request manager 214. Further, the risk analysis server 102 is connected to the plurality of data sources, such as the data source 104a, the data source 104b, and the data source 104c. The processor 208 includes a pre-processor 204 and a Common Knowledge Base (CKB) Generator 206. Further, the database 210 includes a CKB 212.

The data sources 104a-104c store the financial reports submitted by the companies. In an embodiment of the disclosure, for the companies operating in the U.S. the layout of the financial reports is decided by the SEC. According to this layout, a typical annual financial report (10K) and/or quarterly financial report (10Q) contain multiple items (also referred to as sub-sections). Examples of the items include, but are not limited to, business (item 1), legal proceedings (item 3), selected financial data (item 6), financial statements and supplementary data (item 8), and the like. Together these sections present all-inclusive details on a company's business and performance. One key item in the SEC complaint 10K/10Q financial reports is item 1A, which corresponds to “Risk Factors”. Under this item, the companies are required to discuss the most significant factors that make the company speculative or risky. In other words, this item includes details of the qualitative factors that affect a company's performance. These qualitative factors correspond to the macro-environmental risk factors such as, but not limited to, political/legal, economic, social, demographic, technological, and the like. Typically, the companies add headings under the items 1a to list down the risk factors that affect its business. Examples of such headings include, but are not limited to:

a) an industry is subject to competition in an environment of rapid technological change that could result in decreased demand and/or declining average selling prices for the products;

b) a company derives a significant portion of their consolidated revenues from a small number of customers and licensees. If revenues derived from these customers or licensees decrease or the timing of such revenues fluctuates, the company's operating results could be negatively affected;

c) a company's financial condition may be negatively impacted by conditions abroad, including local economics, political environments, fluctuating foreign currencies and shifting regulatory schemes;

d) government contracts are subject to termination rights, audits and investigations, which, if exercised, could negatively impact a company's reputation and reduce its ability to compete for new contracts, and the like.

In addition, each company listed on the SEC's website has a Standard Industrial Classification (SIC) code. An SIC code is a four-digit code assigned to industries, and all companies are categorized under a core industry. For example, the dairy companies have the SIC code 2020, while companies selling/manufacturing beverages have the SIC code 2080.

The risk analysis server 102 of the present disclosure leverages the textual content of the details available in item 1A to assess the investment risk associated with companies of a particular industry sector. The objective is to identify the outlier companies within the industry sector. The term outlier refers to companies with significantly different type or number of risk factors mentioned in financial reports (such as the 10K reports) when compared to other companies belonging to the same industry. In other words, an outlier company is either doing exceptionally well, or it might be indulging in fraudulent practices. To perform such cross-company risk analysis, the risk analysis server 102 takes into account the SIC code of their industry. In addition, while item 1A is a mandatory section of the financial reports, some companies do not disclose the complete risk inducing factors in their financial reports. The cross-company analysis performed by the risk analysis server 102 helps in estimating the missing risk details of a company by examining the risk factors of other companies in the same industry sector.

Referring to FIG. 2, the request manager 214 of the risk analysis server 102 is configured to receive an input from one or more users (not shown) via one or more user devices. The one or more users correspond to financial analysts, investment risk professionals, investors, auditors, accountants, researchers, media personnel, and the like. In another embodiment, the request manager 214 also allows an administrator to remotely access and/or update the programming functionalities or computer code scripts executing on the risk analysis server 102.

A typical user input from the one or more users includes the following fields: a) an SIC code of the industry to be considered b) number of outlier companies to be displayed, and c) the financial year or year range to be considered. In an embodiment of the disclosure, the SIC code may be replaced by a North American Industry Classification System (NAICS code) which is a six-digit code. An exemplary user input is discussed in FIG. 3A. A user accesses the risk analysis server 102 by means of user device (not shown). In an embodiment of the disclosure, the user device allows access to the risk analysis server 102 by means of a browser. In another embodiment, the user device can have a built-in desktop/mobile application that allows online access to the risk analysis server 102. The browser or the built-in desktop/mobile application display a user interface wherein the user enters the SIC code of an industry in a field 302. Example, the SIC code 200 is entered which corresponds to the “Agricultural Prod-Livestock and Animal Specialties” industry. The SIC code is a four digit code. However, if the user enters three digits, a suffix 0 is added to the entered code. In another embodiment, an error can be displayed on the user interface if the code entered by the user contains less than four digits. Next, in a field 304, the user provides the number of outlier companies that should be displayed. Finally, in a field 306 the user enters the financial year that should be considered for the reports. In an embodiment of the disclosure, the financial year can be replaced with financial year range. Example, the user can enter or select years 2012-2014.

When the user clicks on a field 308, the user input is sent to the request manager 214 of the risk analysis server 102. The request manager 214 instructs the crawler 202 to identify all the companies that fall under the SIC code entered in the field 302, and for the financial year provided in the field 306. The crawler 202 fetches financial reports 216 submitted by the identified companies for the selected financial year. The crawler 202 is configured to fetch the financial reports 216 from at least one of the data sources (104a-104c). According to an embodiment of the disclosure, the financial reports 216 are the annual 10K reports filed with the SEC. In other embodiment, 10Q reports can also be considered. The crawler 202 executes one or more scripts that use the Representational State Transfer (REST) Application Program Interfaces (APIs) of the data sources to extract the financial reports 216. Examples of an API includes, but is not limited to, JSON, XML, and the like.

The extracted financial reports 216 are sent to the pre-processor 204 which executes a natural language logic using which all words in the financial reports 216 are syntactically identified. The pre-processor 204 is configured to scan all the financial reports 216 and isolate the details corresponding to the sub-section that enumerates the risk-related details. In case of SEC based filing, this sub-section corresponds to item 1A. Therefore, the pre-processor performs a text search for the string “Item 1A. Risk Factors” within each financial report. The preceding and succeeding sections are truncated and the details illustrated in Item 1A are extracted. Next, the pre-processor 204 normalizes the text within item 1A of each finical report by removing the stop words.

Examples of stop words include, but are not limited to, “a,” “about,” “above,” “after,” “again,” “against,” “all,” “am,” “an,” “and,” “any,” “are,” “aren't,” “as,” “at,” “be,” “because,” “been,” “before,” “being,” “below,” “between,” “both,” “but,” “by,” “can't,” “cannot,” “could,” “couldn't,” “did,” “didn't,” “do,” “does,” “doesn't,” “doing,” “don't,” “down,” “during,” “each,” “few,” “for,” “from,” “further,” “had,” “hadn't,” “has,” “hasn't,” “have,” “haven't,” “having,” “he,” “he'd,” “he'll,” “he's,” “her,” “here,” “here's,” “hers,” “herself,” “him,” “himself,” “his,” “how,” “how's,” “I,” “I'd,” “I'll,” “I'm,” “I've,” “if,” “in,” “into,” “is,” “isn't,” “it,” “it's,” “its,” “itself,” “let's,” “me,” “more,” “most,” “mustn't,” “my,” “myself,” “no,” “nor,” “not,” “of,” “off,” “on,” “once,” “only,” “or,” “other,” “ought,” “our,” “ours,” “ourselves,” “out,” “over,” “own,” “same,” “shan't,” “she,” “she'd,” “she'll,” “she's,” “should,” “shouldn't,” “so,” “some,” “such,” “than,” “that,” “that's,” “the,” “their,” “theirs,” “them,” “themselves,” “then,” “there,” “there's,” “these,” “they,” “they'd,” “they'll,” “they're,” “they've,” “this,” “those,” “through,” “to,” “too,” “under,” “until,” “up,” “very,” “was,” “wasn't,” “we,” “we'd,” “we'll,” “we're,” “we've,” “were,” “weren't,” “what,” “what's,” “when,” “when's,” “where,” “where's,” “which,” “while,” “who,” “who's,” “whom,” “why,” “why's,” “with,” “won't,” “would,” “wouldn't,” “you,” “you'd,” “you'll,” “you're,” “you've,” “your,” “yours,” “yourself,” “yourselves,” and the like.

In an embodiment of the disclosure, an administrator of the risk analysis server 102 can edit the list stop words to be considered (added/deleted/modified) using the request manager 214. Next, for item 1A of each identified company, the pre-processor 204 creates a text dump and consolidates it into a single line. The text dump for each company are then stored in the database 210. Alternatively, the text dump are directly sent to the CKB generator 206.

In an embodiment of the disclosure, if the financial reports 216 are not readable, the pre-processor 204 is configured to use an Optical Character Recognition (OCR) technique to make the financial reports 216 readable and/or editable, prior to processing the text for stop words.

The CKB generator 206 is a decision engine, which is configured to receive and process the text dump to build a CKB 212. The CKB 212 is a processed set of data that identifies the various types of risk factors and the cross-correlation among the companies within an industry sector. The CKB 212 presents aggregate characteristics of the companies within a given industry sector, thereby reducing the effort needed to analyze the risk factors of the companies on an individual basis.

When the text dump for each company is received, the CKB generator 206 uses word stems to create a normalized feature vector. The word stems are based on text mining techniques. An example of text mining includes, but is not limited to, the tf-idf (term frequency-inverse document frequency) of the words. A term frequency (tf) corresponds to the number of times a word appears in a text dump of a company, divided by the total number of words in that text dump. Further, an inverse document frequency (idf) is the logarithm of the number of the text dumps in the corpus (i.e., text dumps of all companies of an industry) divided by the number of text dumps where a specific term appears. According to the tf-idf scheme, a tf-idf weight is used to assess how important a word is to a text dump. The importance of a word increases proportionally to the number of times a word appears in the text dump but is offset by the frequency of the word in the corpus (collection of all text dumps). As an example, the word under consideration is “government” and it is assigned a weight. The CKB generator 206 analyses a text dump of a company of an industry sector (example, the metal cans industry), and identifies that the word “government” appears 7 times. It then proceeds to search for the word in text dumps of other companies of the industry sector metal cans. Based on the frequency of the word “government,” the importance of the word is decided, and a normalized feature vector is created for each text dump.

Next, the CKB generator 206 applies a plurality of distance computation metrics on the normalized feature vector. In an embodiment of the disclosure, the distance computation metric corresponds to the cosine similarity technique. According to the technique, the cosine similarity distance for all normalized feature vectors (for the text dumps belonging to the companies of the same industry sector) is computed. This computation can be performed by first dividing the normalized feature vectors into groups (such as, pairs) and then performing the comparison. Alternatively, the computation can be performed on a first come first serve basis or other similar selection techniques.

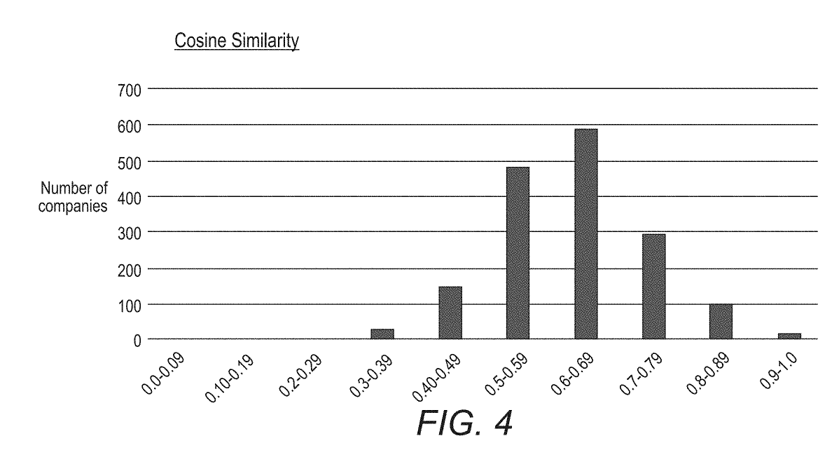

FIG. 4 illustrates a graphical layout of the processing ensued while performing cosine similarity. Mathematically, cosine similarity is expressed as below:

$$Similarity ( x , y ) = cos ( θ ) = \frac{x \cdot y}{‖ x ‖ * ‖ y ‖}$$

wherein, the resulting similarity ranges from: −1 meaning the vectors are exactly opposite, to 1 meaning the vectors are exactly the same. Further, 0 indicates orthogonality or decorrelation, and any value in-between indicates intermediate similarity or dissimilarity. As an example, a word “government” exists at least twice in four normalized feature vectors. The cosine similarity technique determines how close these four vectors are to each other by calculating a function of those four vectors, namely the cosine of the angle between them. The smaller the angle, the closer to 1 the cosine value, hence a greater similarity. This analysis is used to construct the CKB 212 of the normalized feature vectors and the CKB 212 is stored in the database 210. This way the CKB generator 206 takes into account the risk characteristics of all companies within an industry sector and performs a cross-correlation. The aggregate risk characteristics of the companies are then used to build the CKB 212. It should be apparent to a person skilled in the art that the CKB 212 considered herein is a comprehensive repository of risk-related details. The CKB 212 is further sub-divided into a plurality of portions, and each portion stores the aggregate risk details of a particular industry, or a financial year under consideration for an industry. For each new industry, the CKB 212 creates a separate storage portion. In an embodiment, the CKB 212 associates a staleness timer with each portion, such that when the timer expires the aggregated risk details stored in the portion are considered obsolete and removed.

### Temporal Characterization

Once the CKB 212 is built, the risk-related data stored therein is analyzed using one or more temporal characteristics. Examples of temporal characteristics include, but are not limited to, a rate of change in the number of risk factors, a rate of change in the number of companies for a given risk factor, and the like. The temporal characteristics allow effective tracking of the dynamic changes in the industry as well as the impact of those changes on the risk factors. Typically, dynamic changes correspond to the changes in financial value and/or market position of the companies because of competitors, government regulations, taxation policies, inflation, and the like. For example, a company A, was a leading company in a particular industry for more than decade. However, over time, new companies with better technologies and/or new medium of marketing or consumer base entered the industry. Consequently, the profit margins of company A were affected and it was relegated to a lower ranking in the industry. This temporal change is reflected in the financial reports of company A, and the risks are mentioned therein. To capture the dynamic changes, the risk analysis server 102 periodically repeats the process of capturing the financial reports, re-processing the reports to create normalized feature vectors, and then performing a cosine similarity to update the previously stored CKB 212. During each repetition, the changes between the data previously stored and the newly processed data are noted. For example, for the forestry industry (SIC code 0800), at time interval t−1 the CKB 212 included analysis of all prominent risk factors. When the CKB 212 was updated at time interval t, one or more new risk factors emerged in the financial reports. The one or more newly added risk factors are noted and stored in the database 210 and/or within the CKB 212, such that during next update of the CKB 212 the rate of change of risk factors across time intervals can be established. The rate of change of risk factors (and other temporal factors) can also be made available to the users to facilitate investment decision-making. In an embodiment of the disclosure, the frequency of updating the CKB 212 is pre-programmed by an administrator. In another embodiment, the CKB 212 can be updated based on an input received in real-time. Since the CKB 212 is periodically updated, an intra-company insight can also be established, wherein a company's risk details across financial years can be displayed to the user. An input field can be provided on a user interface to enter a company's name or a stock ticker, along with a range of financial years. The output of this query can be in form of a table, a graph, or any other equivalent layout highlighting how the risk factors of the company have changed across financial years.

### Outlier Companies

In context to the disclosure, an outlier company is a company that has significantly different number and/or type of risk factors mentioned in its financial reports when compared to other companies in the industry. An outlier company is either doing exceptionally well, or it might be indulging in fraudulent practices. For example, there is a scenario where the oil and gas market is in an overall slump. However, a company “Z” in the industry is performing exceptionally well, by having many positive statements in its risk factors declaration (in Item 1A of the financial reports). For such a case, there are two possible explanations: a) either the company “Z” is genuinely performing good, in spite of the bad industry environment. This represents a positive outlier. b) or the company “Z” might be trying to create a wrong impression in front of its stakeholders. This represents a negative outlier. Using the CKB 212 and the identified temporal characteristics, the CKB generator 206 performs an inter-company (cross-company) comparison and identifies the outlier companies in an industry. Essentially, when the CKB generator 206 applies the similarity metrics on the normalized feature vectors of all companies, one or more companies with dis-similar risk factors in their normalized feature vectors are identified. Such cases are the outlier companies within the industry. For example, there are four companies “A,” “B,” “C,” and “D” in a particular industry. A similarity value is computed by comparing the normalized feature vectors of all four companies. Below are the exemplary similarity values:

A-B: 0.031

A-C: 0.011

A-D: 0.025

B-C: 0.061

B-D: 0.043

C-D: 0.046

In the above example, the top outlier (i.e., the company with least similarity value) is company “A,” followed by “D”. Referring to FIG. 3A, a user had provided an input in the field 302 to select the companies in the industry sector 0200 (Agricultural Prod-Livestock and Animal Specialties). The financial year to be considered was 2012 (as remarked in the field 306). Further, the user wanted only 5 outlier companies to be displayed (as remarked in the field 304). Consequently, the risk analysis server 102 processed this input and displayed the top five outlier companies as an output 310. In an embodiment, the output 310 can also include a column against each outlier company indicating phrases explaining the prominent one or more risks. In an embodiment of the disclosure, the phrases to be displayed for the one or more risks are identified using the natural language processing logic of the pre-processor 204.

In an embodiment of the disclosure, the top outlier companies to be displayed to the user are selected based on their degree of dissimilarity with other companies in the industry, and/or the temporal characteristics associated with the companies (e.g., rate of change of risk factors). In an embodiment, a weightage can be assigned to the degree of dissimilarity and the temporal characteristics to identify the outlier companies. The data is then displayed to the user in a particular order (ascending/descending). In another embodiment, one or more other quantitative metrics can be additionally used to select the outlier companies. Examples include, but are not limited to, the annual revenue of the companies, the employee strength, and the like. For this purpose, the pre-processor 204 stores the details corresponding to the quantitative details while parsing the financial reports 216 and stores the details in the database 210. The details can be later accessed while accessing the CKB 212. In yet another embodiment, the user may leave the field 304 blank, in which case all outlier companies within the selected industry will be displayed in a pre-defined or a user selected order.

The CKB generator 206 is also configured to identify the risk factors prominently existing in an industry, though missing in the financial reports of a few companies. For example, for the Oil and Gas Field Services industry (SIC code 1389), an analysis by the CKB generator 206 might yield that a prominent macro-environmental risk across majority of companies (first set) is the political issues of Gulf countries. In other words, the status of the political issues in the Gulf region affects the financial performance of the oil and gas based companies in the U.S. This particular risk factor may be missing from the financial reports of a second set of companies categorized under SIC code 1389. Particularly, the number of companies in the first set is greater than the number of companies in the second set. The CKB generator 206 detects this gap and supplements the feature vectors of the second set of companies with this identified risk factor. By this technique, the CKB generator 206 captures high risk related insights by performing a relative risk positioning within an industry.

### Cut-Off Threshold

In FIG. 2, when the CKB 212 is built, all companies that fall under a selected industry are considered for analysis. In an embodiment of the disclosure, a user can limit the number of companies to be analyzed. Typically, if an industry sector has 100 companies, the crawler 202 fetches the financial reports for all 100 companies and the pre-processor 204 processes the reports. The CKB generator 206 proceeds to build a CKB 212 for the 100 companies. However, in the user interface of FIG. 3B, a user can also provide a limit value for the companies to be considered. For example, if a user enters a value 10 in a field 312, the CKB generator 206 selects 10 text dumps of companies from the list of 100 text dumps stored in the database 210 and prepares the normalized feature vectors, followed by performing the similarity comparison between the vectors. In an embodiment of the disclosure, the user also specifies one more quantitative metrics to be considered for shortlisting the companies. This input is provided in a field 314. Examples of the quantitative metrics available in the field 314 include, but are not limited to, highest gross profit, lowest gross profit, highest revenue, lowest employee count, and the like. The quantitative metrics can also correspond to ranges. For example, in the field 314 the user can select ‘Revenue,” and in an additional field (not shown) the user can enter the range of values to be considered for revenue. Based on the input provided in the field 312 and the field 314, the CKB generator 206 performs the cosine similarity between the 10 normalized feature vectors of selected companies and identifies the outliers. For this process, the CKB generator 206 first determines the threshold for the companies that can be flagged as outliers, i.e., the companies having the least similarities with other companies in the same industry sector. In other words, the threshold determines the minimum number of companies (from the 10 selected companies) that can be displayed as outliers. In an embodiment, the following binary search based algorithm is used to identify the threshold. In other embodiments, one or more other search-based algorithms can be used.

max_Number_Of_Companies=N min=0

max=1

threshold=0 watchlist_companies=[ ] while(1):

list_companies=[ ] mid=(min+max)/2 if(company_similarity_score<mid)

list_companies.append(company_name) if len(list_companies)<N:

min=mid

else if len(list_companies)>N: max=mid

else if len(list_companies)==N:

threshold=mid

watchlist_companies=list_companies break

It should be apparent to a person skilled in the art that SEC, item 1A, and the SIC codes relate to the companies operating with the U.S. For other countries, the risk analysis server 102 accesses the websites of their regulatory bodies to access to the financial reports. A different nomenclature may be used by other countries to classify its companies under one or more industries. Further, the details of risks associated with the companies may be available under a different heading and in a different format, and not necessarily as item 1A. The risk analysis server 102 can be programmed to learn the format followed by other countries, and can accordingly execute the process flow discussed in FIG. 2.

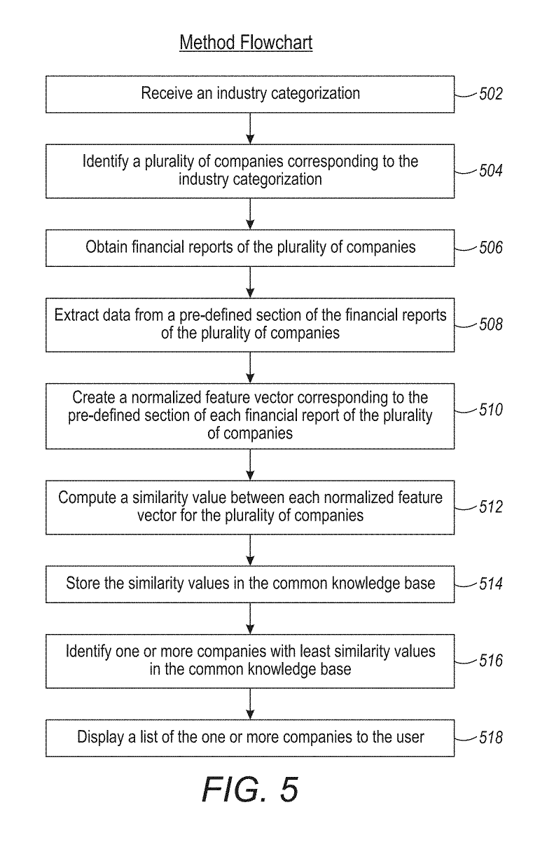

FIG. 5 is a method for analyzing the investment risks of companies in an industry. A user accesses the risk analysis server 102 over the network 108 using one or more user devices. The access to the risk analysis server 102 can be by means of a browser, or via built-in desktop/mobile application executing on the one or more user devices. The request manager 214 of the risk analysis server 102 presents a user interface to the user wherein the user can provide his/her query. At 502, the user enters his/her query by providing an industry categorization code of an industry whose companies need to analyzed for investment risks. The industry categorization code corresponds to a SIC code. In another embodiment, a NAICS code is used as the industry categorization code. At 504, the request manager 214 sends this information to the crawler 202. The crawler 202 identifies a number of companies that are grouped under the provided industry categorization code. At 506, the crawler 202 extracts the financial reports of the companies identified at 504. The financial reports are accessed from one or more data sources remotely hosted from the risk analysis server 102. In an embodiment of the disclosure, the one or more data sources correspond to the SEC database, and the financial reports are extracted by using the APIs provided by the SEC's website. In another embodiment, the one or more data sources correspond to the home website of the identified companies, other financial websites, and the like. The financial reports correspond to the 10K reports which are annually filed by the companies. Moreover, the financial reports may also include 10Q reports, which are filed quarterly.

The extracted financial reports are sent to the pre-processor 204, which extracts data from a pre-defined section, item 1A, of the financial reports of the identified companies at 508. Item 1A enumerates the macro-environmental risk-related details for each company. Examples of the macro-environmental risks can be political/legal, economic, social, demographic, technological, and the like. The pre-processor 204 normalizes the extracted data of item 1A by removing stop words, such as but not limited to, “a,” “the,” “an,” and the like. At 510, the normalized data is sent to the CKB generator 206 which creates a normalized feature vector for item 1A of each identified company. The CKB generator 206 uses the tf-idf technique to identify frequency of words in light of a weightage. The details of the tf-idf have been discussed with respect to FIG. 2. At 512, the CKB generator 206 applies distance computation metrics on the normalized feature vectors of each identified company. An example of the metric includes computing a similarity value by using a cosine similarity technique. In other words, a cross-company risk is assessed by comparing the degree of similarity between the normalized feature vectors of all companies in an industry. At 514, the similarity values are stored in the database 210, along with the normalized feature vectors. At 516, the CKB generator 206 identifies one or more companies from the identified companies with the least similarity values, and displays (within the user interface) a list of the one or more companies to the user via the request manager 214. The one or more companies with least similarity values indicate that these are outliers in the industry. In other words, the one or more companies have one or more different investment risks as compared to other companies in the selected industry. Finally, at 518, a list of the one or more companies are displayed to the user.

The disclosure may be implemented in many day-to-day scenarios, such the one discussed below. It is apparent to a person skilled in the art that the following case scenarios are exemplary in nature. Various other scenarios can be realized across a plurality of business sectors.

### Use Case 1: Fraud Detection

High-risk industries, such as the retirement asset planning industry, are plagued with investment risks in long-term investments. The risk analysis server 102 can be used to identify companies with high risk in such industries, or to identify companies that are performing well contrary to industry expectations. In other words, the companies indulging in fraudulent practices can also be identified. Such information can be leveraged to plan investments in companies.

### Use Case 2: Supply Chain Management

The risk analysis server 102 can be used by companies to understand the risk factors of other companies in its supply chains. For example, if a company “B” provides raw materials for a manufacturing company “A” and it is at significant risk of bankruptcy, the manufacturing company “A” can identify this risk and can decide to deselect the company “B” from its list of raw materials supplier firms.

### Use Case 3: Checking Completeness of Financial Reports

In an embodiment, the risk analysis server 102 can present an interface to the users to input only one company's name or ticker. The pre-processor 204 parses the item 1A of the selected company's financial report using natural language processing. The CKB generator 206 is configured to flag the missing risk details within the item 1A. The missing risk details can be ascertained by comparing the item 1A across company's previous financial reports. In another embodiment, the missing risk details are ascertained by comparing the item 1A details of the company with the aggregated risk factors of other companies in the same industry. The feature of highlighting missing details can be leveraged by the users to ensure and validate the completeness of the declared risk factors in their financial reports.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating” or “monitoring” or “displaying” or “tracking” or “identifying” “or receiving” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for identifying one or more companies from a plurality of companies in an industry, the one or more companies having one or more investment risks different from investment risks of other companies in the plurality of companies, the identification being performed by a risk analysis server, in communication with a user device in a real-time, the method comprising:
receiving, by the risk analysis server, an industry categorization code of the industry through a user interface on the user device;
identifying, by the risk analysis server, the plurality of companies belonging to the industry categorization code from one or more remote data sources;
obtaining, by the risk analysis server, financial reports corresponding to the plurality of identified companies from the one or more remote data sources;
creating, by the risk analysis server, a common knowledge base, wherein creation of the common knowledge base comprising:
extracting data from a pre-defined section of the financial reports of the plurality of companies, wherein the pre-defined section includes investment risk related qualitative details for the plurality of companies;
creating a normalized feature vector corresponding to the extracted data of each of the plurality of companies;
computing a similarity value between each normalized feature vector for each of the plurality of companies;
storing the similarity values in the common knowledge base;
identifying, by the risk analysis server, one or more companies from the plurality of companies with least similarity values in the common knowledge base, wherein the least similarity values correspond to one or more investment risks different from investment risks of other companies in the plurality of companies; and
displaying, by the risk analysis server, a list of the one or more companies to the user in a real-time, within the user interface.

2. The method of claim 1, wherein the industry categorization code is a Standard Industrial Classification (SIC).

3. The method of claim 1, wherein the financial reports are annual 10K reports.

4. The method of claim 1, wherein the one or more remote data sources are Securities Exchange Commission (SEC) data source.

5. The method of claim 1, wherein the pre-defined section is item 1A of the financial reports.

6. The method of claim 1, wherein after extracting the data from a pre-defined section of the financial reports, the risk analysis server removes a plurality of pre-defined stop words from the data.

7. The method of claim 1, wherein the normalized feature vector is created using a term frequency-inverse document frequency technique.

8. The method of claim 1, wherein the similarity values between each normalized feature vector for the plurality of companies is identified using a cosine similarity metric.

9. The method of claim 1, wherein the common knowledge base is updated periodically.

10. The method of claim 1, wherein the risk analysis server further comprising assigning one or more temporal characteristics to the normalized feature vectors of the plurality of companies.

11. A method for creating a common knowledge base for a plurality of companies in an industry, the common knowledge base stores one or more investment risk insights for each of the plurality of companies, the method comprising:
extracting a plurality of investment risk data from a pre-defined section of financial reports of the plurality of companies, wherein the pre-defined section includes investment risk related qualitative details for the plurality of companies, and the financial reports are accessed from one or more remote data sources;
creating a normalized feature vector corresponding to the plurality of extracted investment risk data of each of the plurality of companies;
computing a similarity value between each normalized feature vector for each of the plurality of companies;
storing the similarity values and the normalized feature vector in a database;
processing the similarity values to identify one or more investment risk insights for each of the plurality of companies; and
storing the one or more investment risk insights for each of the plurality of companies for further retrieval.

12. The method of claim 11, wherein the pre-defined section is item 1A of the financial reports.

13. The method of claim 11, wherein the normalized feature vector is created using a term frequency-inverse document frequency technique.

14. The method of claim 11, wherein the similarity values between each normalized feature vector for the plurality of companies is identified using a cosine similarity metric.

15. The method of claim 11, wherein the common knowledge base is updated periodically.

16. The method of claim 11, wherein the risk analysis server further performs assigning one or more temporal characteristics to the normalized feature vectors of the plurality of companies.

17. A method for identifying one or more missing investment related risk details in financial reports of one or more companies in an industry, the identification being performed by a risk analysis server, the method comprising:
obtaining, by the risk analysis server, financial reports corresponding to a plurality of companies of an industry from one or more remote data sources;
creating, by the risk analysis server, a common knowledge base, wherein creation of the common knowledge base comprising:
extracting data from a pre-defined section of the financial reports of the plurality of companies, wherein the pre-defined section includes investment risk related qualitative details for the plurality of companies;
creating a normalized feature vector corresponding to the extracted data of each of the plurality of companies;
computing a similarity value between each normalized feature vector for each of the plurality of companies; and
identifying, by the risk analysis server, one or more investment related risks details available in a first set of the plurality of companies, the identification being made using the computed similarity values, wherein the one or more investment related risks are not present in a second set of the plurality of companies, the number of companies in the first set is greater than the second set.

18. A risk analysis server for identifying one or more companies from a plurality of companies in an industry, the one or more companies having one or more investment risks different from investment risks of other companies in the plurality of companies, the risk analysis server comprises:
a request manager configured for receiving an industry categorization code of the industry from a user;
a crawler configured for:
identifying the plurality of companies belonging to the industry categorization code from one or more remote data sources;
obtaining financial reports corresponding to the plurality of identified companies from the one or more remote data sources;
a common knowledge base generator configured for creating a common knowledge base, wherein creation of the common knowledge base comprising:
extracting data from a pre-defined section of the financial reports of the plurality of companies, wherein the pre-defined section includes investment risk related qualitative details for the plurality of companies;
creating a normalized feature vector corresponding to the extracted data of each of the plurality of companies;
computing a similarity value between each normalized feature vector for each of the plurality of companies;
storing the similarity values in the common knowledge base;
identifying one or more companies from the plurality of companies with least similarity values in the common knowledge base, wherein the least similarity values correspond to one or more investment risks different from investment risks of other companies in the plurality of companies; and
displaying a list of the one or more companies to the user.

19. The system of claim 18, wherein the industry categorization code is a Standard Industrial Classification (SIC).

20. The system of claim 18, wherein the financial reports are annual 10K reports.

21. The system of claim 18, wherein the one or more remote data sources are a Securities Exchange Commission (SEC) data source.

22. The system of claim 18, wherein the pre-defined section is item 1A of the financial reports.

23. The system of claim 18, wherein the normalized feature vector is created using a term frequency-inverse document frequency technique.

24. The system of claim 18, wherein the similarity values between each normalized feature vector for the plurality of companies is identified using a cosine similarity metric.

25. The system of claim 18, wherein the common knowledge base is updated periodically.

26. The system of claim 18 is further configured for assigning temporal characteristics to the normalized feature vectors of the plurality of companies.
